(19) United States
(12) Patent Application Publication
(10) Pub. No.: US 2011/0264340 A1
(43) Pub. Date: Oct. 27, 2011

(54) AUTOMATIC TRANSMISSION FOR VEHICLE

(76) Inventors: Sang Heon Lee, Hwaseong-si (KR); Sang Hyun Kim, Anyang-si (KR)

(21) Appl. No.: 12/952,997

(22) Filed: Nov. 23, 2010

(30) Foreign Application Priority Data
Apr. 22, 2010 (KR) 10-2010-0037250

(51) Int. Cl. B60W 10/02; B60W 30/18; B60W 10/10; F16H 59/10

(52) U.S. Cl. 701/53; 74/473.3

(57) ABSTRACT

Provided is an automatic transmission for a vehicle, and more particularly, an automatic transmission for a vehicle which controls a clutch actuator to operate a clutch for forward and reverse operations of the vehicle and for changing running speeds so as to interrupt engine power transmission, thereby automating inconvenient clutch manipulations. The automatic transmission for a vehicle which changes a rotation direction of power and a rotation speed range from an engine, includes: a forward/reverse shifter for changing the rotation direction of the power transmitted from the engine; a running speed shifter for changing a rotation speed range of the forward/reverse shifter; a main shifting actuator for driving the running speed shifter; a clutch for selectively interrupting the power transmitted from the engine during a shifting procedure of the running speed shifter; a clutch actuator for driving the clutch; and a controller for driving the clutch by controlling the clutch actuator to interrupt the power transmitted from the engine when a shift signal for the running speed shifter is input, for driving the running speed shifter by controlling the main shifting actuator, and when the shifting procedure is completed, for controlling the clutch actuator again to return the clutch to its initial position.

### CROSS-REFERENCE TO RELATED APPLICATION

This application claims priority to Korean Patent Application No. 10-2010-0037250, filed on Apr. 22, 2010, and all the benefits accruing therefrom under 35 U.S.C. §119, the contents of which in its entirety are herein incorporated by reference.

### BACKGROUND

1. Field

This disclosure relates to an automatic transmission for a vehicle, and more particularly, to an automatic transmission for a vehicle which controls a clutch actuator to operate a clutch for forward and reverse operations of the vehicle and for changing running speeds so as to interrupt engine power transmission, thereby automating inconvenient clutch manipulations.

2. Description of the Related Art

A tractor has a transmission for transmitting engine power. The transmission is provided with a power take-off (PTO) clutch for driving an operating machine by selectively receiving the engine power without a main transmission therebetween.

FIG. 1 is a diagram schematically illustrating a configuration of a tractor, and FIG. 2 shows a powertrain of the tractor.

As illustrated in FIG. 1, a tractor 10 is equipped with a frame 13 having steering front wheels 11 and driving rear wheels 12, and an engine 20 and a transmission 30 are sequentially mounted on the frame 13 from front to back. In addition, a driver's compartment 14 is provided above the frame 13 in the rear of the engine 20. A rear axle shaft 40 for driving the rear wheels 12 is connected to the rear side of the transmission 30. A PTO shaft 41 extends from a PTO shifting unit of the transmission 30 to operate an operating machine installed at a lifting device 50 at the rear.

The transmission 30 includes, as illustrated in FIG. 2, a forward/reverse shifter 31 for shifting between forward (positive rotation) and reverse (reverse rotation) for transmission of rotative power from the engine 20, a main shifting unit 32 for changing running speed of the tractor in multi stages (typically 4 stages), a sub shifting unit 33 for extending the speed change of the main shifting unit 32 to multi stages (typically 2 to 4 stages), and a final speed reduction unit 34 which is connected to an output shaft of the sub shifting unit 33 to finally reduce the speed and simultaneously to change the transmission direction of the power transmitted to the rear axle shaft 40. In addition, a PTO unit 35 which receives the power from the main shifting unit 32 to transmit the power to the operating machine is included.

In the tractor, forward, neutral, and reverse are selected by manipulating a forward/reverse lever installed in the rider drive unit, high-speed and low-speed of the sub shifting unit 33 are selected by manipulating a high/low shift lever, and the speed of the main shifting unit 32 is selected as a needed speed by manipulating a main shift lever. Depending on the selections, transmission is made by means of an internal hydraulic clutch mechanism or a synchronization mechanism.

To shift gears in a manual transmission vehicle such as an existing tractor, a driver operates a clutch pedal to release the link between an engine rotation shaft and a load shaft by a clutch and manually manipulates a shift lever to operate gears.

However, the procedure is inconvenient, and if the shifting operation is performed compulsively while the clutch pedal is not fully depressed, shift shock may occur. When the shift shock occurs, a phenomenon in which the tractor clatters may occur, so that there is a problem in that undue stress may be applied to each component of the powertrain.

### SUMMARY

This disclosure provides an automatic transmission for a vehicle which is provided with a clutch actuator and a main shifting actuator without a change in an existing manual transmission system structure, thereby automating inconvenient clutch manipulations to change the speed during movement of the vehicle.

In one aspect, there is provided an automatic transmission for a vehicle which changes a rotation direction of power and a rotation speed range from an engine, including: a forward/reverse shifter for changing the rotation direction of the power transmitted from the engine; a running speed shifter for changing a rotation speed range of the forward/reverse shifter; a main shifting actuator for driving the running speed shifter; a clutch for selectively interrupting the power transmitted from the engine during a shifting procedure of the running speed shifter; a clutch actuator for driving the clutch; and a controller for driving the clutch by controlling the clutch actuator to interrupt the power transmitted from the engine when a shift signal for the running speed shifter is input, for driving the running speed shifter by controlling the main shifting actuator, and when the shifting procedure is completed, for controlling the clutch actuator again to return the clutch to its initial position.

The automatic transmission may further include: a forward/reverse lever switch of a switch type which inputs a start signal to change the rotation direction of the power from the engine; and a forward/reverse actuator for driving the forward/reverse shifter according to the controlling of the controller depending on positions of the forward/reverse lever switch. When a forward/reverse shift signal is input through the forward/reverse lever switch, the controller may drive the clutch by controlling the clutch actuator to interrupt the power transmitted from the engine, drive the forward/reverse shifter by controlling the forward/reverse actuator, and when the forward/reverse shifting procedure is completed, it may control the clutch actuator again to return the clutch to the initial position.

The automatic transmission may further include a forward/reverse actuator sensor for sensing a displacement value of the forward/reverse actuator and transmitting the displacement value to the controller. The controller may analyze the sensing values input from the forward/reverse actuator sensor and generate a control signal for driving the clutch actuator.

The automatic transmission may further include a clutch actuator sensor for sensing a displacement value of the clutch actuator and transmitting the displacement value to the controller. The controller may analyze the sensing values input from the clutch actuator and generate a control signal for driving the forward/reverse actuator or the main shifting actuator.

The automatic transmission may further include a main shift lever switch of a switch type which inputs a start signal to change the rotation speed range of the power from the engine.

The automatic transmission may further include an electronic brake for braking or controlling gears rotating in the forward/reverse shifter or the running speed shifter so as not to exceed the set speed ranges.

The automatic transmission may further include: an input speed sensor for sensing the rotation drive speed of the engine; and an output speed sensor for sensing a speed of an output shaft of the forward/reverse shifter.

According to the disclosed automatic transmission for a vehicle, the clutch actuator and the main shifting actuator are simply added without changing an existing manual transmission system structure. Therefore, clutch manipulations may be automated at low cost.

According to the disclosed automatic transmission for a vehicle, inconvenient clutch manipulations needed to change the speeds during driving can be omitted, thereby achieving convenience of shifting manipulations.

According to the disclosed automatic transmission for a vehicle, the clutch actuator is instantly controlled by the controller to change the running speed, thereby minimizing power interruption phenomenon.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a diagram schematically illustrating a configuration of a tractor;

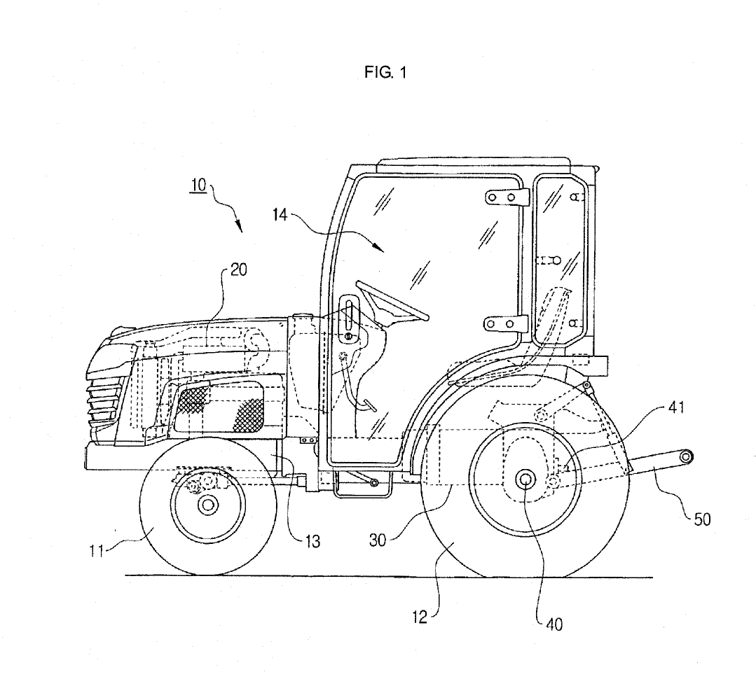

FIG. 2 shows a powertrain of the tractor; and

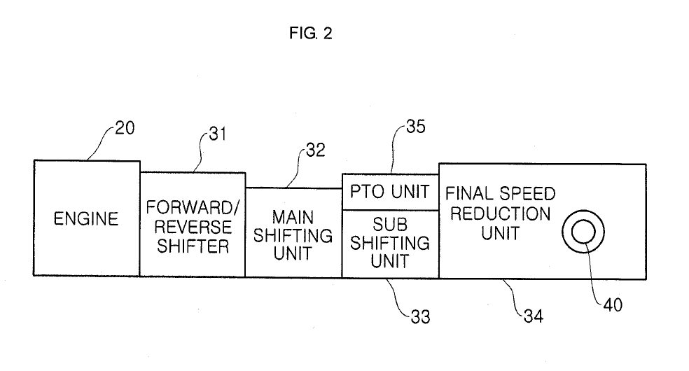

FIG. 3 is a block diagram schematically illustrating a configuration of an automatic transmission for a vehicle according to an embodiment.

### DETAILED DESCRIPTION

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

Hereinafter, an automatic transmission for a vehicle according to exemplary embodiments will be described in detail with reference to the accompanying drawings.

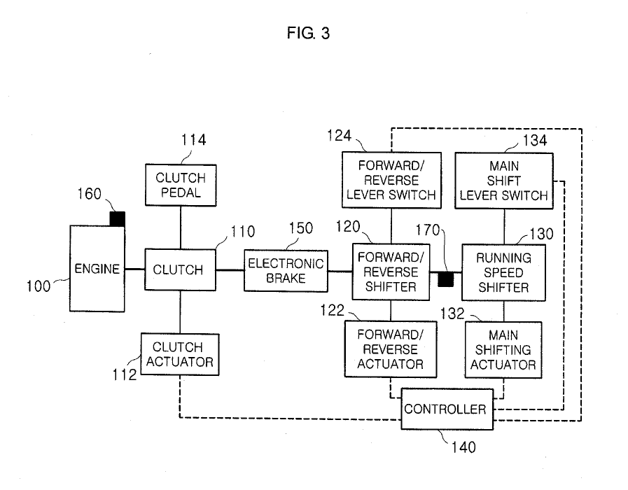

FIG. 3 is a block diagram schematically illustrating a configuration of an automatic transmission for a vehicle according to an embodiment.

Referring to FIG. 3, an automatic transmission according to this embodiment includes a clutch 110, a clutch actuator 112, a forward/reverse shifter 120, a running speed shifter 130, a main shifting actuator 132, and a controller 140, and may optionally include a clutch pedal 114, a forward/reverse shifting actuator 122, a forward/reverse lever switch 124, a main shift lever switch 134, an input speed sensor 160 and/or an output speed sensor 170.

The clutch 110 selectively interrupts power transmission from the engine 110 to the shifters 120 and 130 when a user shifts between forward and reverse of the vehicle and changes the running speed. The clutch actuator 112 drives a motor to operate the clutch 110 when a shift start signal is input through the main shift lever switch 134 even when the user manipulates the main shift lever switch 134 without depressing the clutch pedal 114.

Specifically, the clutch actuator 112 operates the clutch 110 by driving the motor and moving a clutch release hub.

When the clutch 110 is operated as the clutch actuator 112 is driven, power transmission from the engine 110 may be interrupted, and it is possible to prevent damage of the powertrain in the vehicle which may occur when the transmission is made while the power transmission from the engine 110 is not interrupted.

The forward/reverse shifter 120 changes rotation directions of the power transmitted from the engine 100 to selectively move the vehicle forward and reverse. The forward/reverse actuator 122 drives the forward/reverse shifter 120 according to controlling of the controller 140. The forward/reverse lever switch 124 is a unit for inputting a start signal for changing the direction of the rotative power of the engine 100. Here, the forward/reverse lever switch 124 according to this embodiment is in a switch type such that it can be easily manipulated by the user and may have the same configuration as an existing forward/reverse lever.

The user may set forward, neutral, and reverse through the forward/reverse lever switch 124, and a synchromesh of the forward/reverse shifter 120 is finally engaged with a forward gear or a reverse gear according to the start signal from the forward/reverse lever switch 124 thereby changing the direction of the rotative power of the engine 100.

Specifically, to move a stopping vehicle forward, the driver places the forward/reverse lever switch 124 to forward from neutral. Here, the controller 140 senses an electric lever manipulation signal and operates the clutch actuator 112 to move the clutch release hub such that the clutch 110 is released and simultaneously the transmission of the engine power is interrupted.

Subsequently, when the clutch 110 is released, the controller 140 transmits a signal for operating the forward/reverse actuator 122, and the forward/reverse actuator 122 operates the motor according to the controlling of the controller 140 to rotate a forward/reverse lever shaft such that a sleeve of the synchromesh is positioned to engage with the forward gear. Here, when the clutch actuator sensor (not shown) is further provided, a displacement value of the clutch actuator 112 is transmitted to the controller 140 so as to allow the controller 140 to more precisely control the operation of the forward/reverse actuator 122.

When the operation of engaging the sleeve of the synchromesh of the forward/reverse shifter 120 with the forward gear is completed, the controller 140 transmits a signal for driving the clutch actuator 112 again. During starting, in consideration of impact applied to the vehicle, the clutch actuator 112 operates the clutch 110 to be partially engaged so as to slowly start the vehicle, and drives the clutch 110 to be positioned in an initial state again after starting. Here, when a forward/reverse actuator sensor (not shown) is further provided, a displacement value of the forward/reverse actuator 122 is sensed is transmitted to the controller 140 so as to allow the controller 140 to more precisely control a time to operate the clutch actuator 112.

On the other hand, when the driver wants to move backward, the drive places the forward/reverse lever switch 124 to reverse. Then, the controller 140 senses the electric lever manipulation signal and operates the clutch actuator 112 to move the clutch release hub such that the clutch 110 is released and simultaneously the transmission of the engine power is interrupted. Subsequently, when the clutch 110 is released, the controller 140 transmits the signal for operating the forward/reverse actuator 122, and the forward/reverse actuator 122 operates the motor according to the controlling of the controller 140 to rotate the forward/reverse lever shaft such that the sleeve of the synchromesh is positioned to be engaged with the reverse gear. When the synchromesh of the forward/reverse shifter 120 is finally engaged with the reverse gear, the controller 140 controls the clutch actuator 112 to return the clutch 110 to its initial state.

The running speed shifter 130 changes a rotation speed range of the forward/reverse shifter 120, and the main shifting actuator 132 drives the running speed shifter 130 according to the controlling of the controller 140. The main shift lever switch 134 is a unit for inputting a signal for main transmission of the engine 100 during running of the vehicle.

When the driver wants to change the vehicle speed range while the vehicle is moving, the driver places the main shift lever switch 170 in a desired speed range. The main shift lever switch 170 according to this embodiment is of a switch type unlike an existing lever type and thus it can be manipulated easily and does not have a clutch manipulation button that is typically attached to a main shift lever. The controller 140 senses the electric lever manipulation signal and operates the clutch actuator 112 to move the clutch release hub such that power transmission from the engine is interrupted by the clutch 110.

Thereafter, the controller 140 senses a displacement value signal of the clutch actuator 112 and moves a shift fork connected to the main shifting actuator 132 such that the shift sleeve of the synchromesh is engaged with a gear in the desired speed range. Here, when the clutch actuator sensor is further provided, the displacement value of the clutch actuator 112 is transmitted to the controller 140 so as to allow the controller 140 to more precisely control an operation time of the main shifting actuator 132.

Subsequently, the controller senses the displacement value of the main shifting actuator 132 and controls the clutch actuator 112 to return the clutch 110 operated to interrupt the power transmission from the engine 100 to the initial position and thus transmit the power of the engine 100 to the shifters 120 and 130.

An electronic brake 150 brakes or controls gears rotating in the forward/rearward shifter 120 or in the running speed shifter 130 so as to prevent exceeding set speed ranges. According to an embodiment, the electronic brake 150 senses a position of the main shift lever switch 134 to control the vehicle to run in a speed range of the set position.

According to another embodiment, the input speed sensor 160 and the output speed sensor 170 may be further provided.

The input speed sensor 160 senses a rotation drive speed of the engine 100, and the output speed sensor 170 senses a rotation speed of an output shaft of the forward/reverse shifter 120.

Sensing values acquired by the input speed sensor 160 and the output speed sensor 170 are transmitted to the controller 140, and the controller 140 compares the sensing values and analyzes them. When a phenomenon in which the engine power is not sufficiently transmitted to the output shaft of the forward/reverse shifter 120 or the like is sensed, the controller 140 determines an error of the powertrain and generates a control signal for driving the clutch actuator 112 or the like.

According to this embodiment, the clutch actuator 112, the forward/reverse actuator 122, the main shifting actuator 132, and the like may be added to be used without changing a structure of an existing manual transmission system.

In addition, according to an embodiment, the automatic transmission may include the clutch pedal 114 according to the related art. Thus, the user can manually perform a shifting operation by directly depressing the clutch pedal 114 without driving the clutch actuator 120.

While the exemplary embodiments have been shown and described, it will be understood by those skilled in the art that various changes in form and details may be made thereto without departing from the spirit and scope of this disclosure as defined by the appended claims.

In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

What is claimed is:

1. An automatic transmission for a vehicle which changes a rotation direction of power and a rotation speed range from an engine, comprising:
a forward/reverse shifter for changing the rotation direction of the power transmitted from the engine;
a running speed shifter for changing a rotation speed range of the forward/reverse shifter;
a main shifting actuator for driving the running speed shifter;
a clutch for selectively interrupting the power transmitted from the engine during a shifting procedure of the running speed shifter;
a clutch actuator for driving the clutch; and
a controller for driving the clutch by controlling the clutch actuator to interrupt the power transmitted from the engine when a shift signal for the running speed shifter is input, for driving the running speed shifter by controlling the main shifting actuator, and when the shifting procedure is completed, for controlling the clutch actuator again to return the clutch to its initial position.

2. The automatic transmission according to claim 1, further comprising:
a forward/reverse lever switch of a switch type which inputs a start signal to change the rotation direction of the power from the engine; and
a forward/reverse actuator for driving the forward/reverse shifter according to the controlling of the controller depending on positions of the forward/reverse lever switch,
wherein, when a forward/reverse shift signal is input through the forward/reverse lever switch, the controller drives the clutch by controlling the clutch actuator to interrupt the power transmitted from the engine, drives the forward/reverse shifter by controlling the forward/reverse actuator, and when the forward/reverse shifting procedure is completed, controls the clutch actuator again to return the clutch to the initial position.

3. The automatic transmission according to claim 2, further comprising a forward/reverse actuator sensor for sensing a displacement value of the forward/reverse actuator and transmitting the displacement value to the controller,
wherein the controller analyzes the sensing values input from the forward/reverse actuator sensor and generates a control signal for driving the clutch actuator.

4. The automatic transmission according to claim 2, further comprising a clutch actuator sensor for sensing a displacement value of the clutch actuator and transmitting the displacement value to the controller,
wherein the controller analyzes the sensing values input from the clutch actuator and generates a control signal for driving the forward/reverse actuator or the main shifting actuator.

5. The automatic transmission according to claim 1, further comprising a main shift lever switch of a switch type which inputs a start signal to change the rotation speed range of the power from the engine.

6. The automatic transmission according to claim 1, further comprising an electronic brake for braking or controlling gears rotating in the forward/reverse shifter or the running speed shifter so as to prevent exceeding the set speed ranges.

7. The automatic transmission according to claim 1, further comprising:
an input speed sensor for sensing the rotation drive speed of the engine; and
an output speed sensor for sensing a speed of an output shaft of the forward/reverse shifter.
